(19) United States
(12) Patent Application Publication
(10) Pub. No.: US 2009/0192674 A1
(43) Pub. Date: Jul. 30, 2009

(54) Hydraulically propelled - gryoscopically stabilized motor vehicle

(76) Inventor: Gerald Frank Simons, Bosque Farms, NM (US)

Correspondence Address: Gerald F. Simons, 570 Green Acres Lane, Bosque Farms, NM, 87068, US

(21) Appl. No.: 12/321,040

(22) Filed: Jan. 15, 2009

Related U.S. Application Data
(60) Provisional application No. 61/062,152, filed on Jan. 24, 2008.

(51) Int. Cl. B60G 17/018; G06F 17/00

(52) U.S. Cl. 701/37

(57) ABSTRACT

A hydraulically propelled, gyroscopically stabilized muter vehicle that exhibits extremely high fuel efficiency and personnel safety. Fuel efficiency is derived from the application of a large energy wheel functioning to provide energy storage as well as inertial stabilization The energy wheel never needs to be replaced and when its energy level as been depleted can be refilled almost immediately. Additional energy is stored in a conventional hydraulic accumulator. A small engine running intermittently for a short time and st its most efficient speed replaces expended energy. Expended energy is also replaced by regenerative decelerations well as wheel bounce. Safety is enhanced by the inertial stability of the energy wheel functioning as a gyroscope that prevents the vehicle from overturning. A Rate Gyroscope in conjunction with a computer controlled vehicle control system prevent spin out accidents.

### CROSS REFERENCE TO RELATED APPLICATIONS

This application claims the benefit of Provisional Patent Application No. 61/062,152

### FEDERALLY SPONSORED RESEARCH

Not applicable

### SEQUENCE LISTING OR PROGRAM

Not applicable

### BACKGROUND

1. Field of Invention

The present invention relates to motor vehicles, specifically motor vehicles maximizing energy savings while being propelled by hydraulic motors, stabilized by gyroscopes, controlled by an onboard or remote operator commanding vehicle action from on board computer(s) and with active pneumatic/hydraulic suspension.

2. Prior Art

Self propelled vehicles acquiring the term “Automobiles” or “Car” became practical with the invention of the internal combustion engine. Up to that time, wheeled transportation was typically horse drawn vehicles that received their propulsion from being drawn forward and their steering from having the front wheels turned causing the body of the vehicle to follow. With the advent of self-propulsion, the vehicle was propelled by means of friction developed between the wheels and the road surface. Steering was accomplished by turning the front wheels thus generating the force necessary to cause the vehicle to turn by the friction between the turning front wheels and the road surface. Such vehicle steering concept generates the propensity for the vehicle to roll over when a turning at a high rate of speed.

The internal combustion engine was connected to the wheels through a gearing system causing the speed of the engine to determine the speed of the vehicle. Further gearing consideration was required to accommodate the difference in wheel speed from the innermost wheel of the turn to the outermost wheel. Those two wheels had to turn at different rates to prevent the wheels from skidding. Gear trains generate inefficiencies.

Because of that extremely inefficient propulsion and steering system and because of the requirement for large energy bursts in the event of high rate acceleration, huge engines have been used. This led to extreme fuel consumptions and as long as the current methods were used in the management of the vehicle, there was no practical way to significantly improve that energy performance. Braking is done by friction wasting all the accumulated kinetic energy of the vehicle. The technology developed more than 100 years ago is still in use today. Improvements have been made in the various components of the system such as better engines, better gear trains and others improvements, but overall fuel efficiency is limited.

The principal offender is the large internal combustion engine whose efficiency varies with speed over a range of 10% to a maximum of 35%. In an effort to reduce the size of the engine, battery powered electric motors were then used to boost the capability of the internal combustion engine when high rate accelerations were required. This allowed the engine size to be reduced and with it the reduction the magnitude of the of losses due to engine inefficiency. Unfortunately, batteries do not have a good energy to weight ratio so that the addition of the battery bank offset the weight reduction due to a smaller engine. The added electric motor and associated equipment added to the increased weight. The energy stored in the battery is quickly drained and then the engine must run to replace that energy while at the same time providing the energy necessary to run the car. Batteries cannot be recharged quickly so that it takes a relatively long time to recharge a battery that has been discharged.

In addition, only approximately 10% of the total battery capacity is available for use. As the battery is used its voltage declines so that when its terminal voltage has declined by approximately 10% the battery may not be discharged further without being destroyed. As an example the battery pack in a current model battery hybrid vehicle has a battery pack with a capacity of 1700-watt hours, only 170-watt hours of which are available for use. To put that in terms of power availability, that amount of energy would run a typical vehicle for approximately 2½ minutes at highway speeds. Additionally, batteries are expensive, and begin to degrade immediately in use. The maximum life expectancy is 8 years at the end of which time even that capability is completely gone and the batteries must be replaced at a large cost. In general the battery-powered hybrid is not a solution to the fuel efficiency problem.

In addition to the poor fuel efficiency, the conventional steering system allows the inadvertent roll over of the vehicle when the operator initiates a turn at an improper speed.

Additionally, should an inadvertent occasion arise such as a blowout or icy road the operator of the vehicle may not be able to control the vehicle as a result of the event and the vehicle spins out causing a potential rollover.

The auto industry has generated practice of obsoleting each year's car model in order to generate a market for next year's car. This results in a huge cost to the public in having to pay for retooling every year. The public wants new models but should not have to pay for retooling every car each year.

### SUMMARY OF THE INVENTION

Accordingly it is the object of the present invention to provide a vehicle whose performance with significantly improved fuel efficiency under equivalent demands is equal to or better than the existing wheeled self-propelled land vehicles.

Another object of the present invention is to provide a standardized platform upon which any appropriately configured cargo, including a conventional passenger car body may be mounted.

Yet another object of the present invention is to provide a vehicle that prevents rollover and spin out accidents.

Still another object of the present invention is to provide a vehicle that allows its operation to be directed by an onboard operator or by commands generated by on board programs or commands emanating elsewhere.

To meet these objects a totally new and improved vehicle operational system is required.

New and improved propulsion, steering, energy management and vehicle control system are employed. The vehicle of the present invention is basically a platform upon which a body such as that of a family car or conventional pick up may be mounted. The total vehicle is then capable of traveling with fuel efficiency far in excess of that of the existing vehicles while using any kind of available fuel for which the engine was designed. It can be built of currently available parts with no component Research and Development effort being required. It costs less than the cost of the conventional car to manufacture. Its ownership costs are reduced to only minor maintenance.

Propulsion is accomplished by the use of a hydraulic motor driving each driving wheel with the other wheels castoring. In the case of a rear wheel drive vehicle, a hydraulic motor being attached to each wheel drives the rear wheels while the front wheels castor. The speed of the vehicle is commanded by the operator to a computer that then causes the driving wheels to turn at the rate necessary for the vehicle to meet the commanded speed. With both driving wheels turning at the same speed, the car will traverse a straight line. When the operator wants to turn, a command is given to the computer directing a turn rate. The computer then causes each wheel drive motor to rotate at a calculated different rate that will cause the vehicle to turn at the commanded rate. A Rate Gyroscope confirms that the commanded vehicle turn rate has been met. As the vehicle turns, the wheels, which are designed to castor, follow the commanded vehicle turn rate.

Only rolling friction and aerodynamic drag cause the expenditure of energy.

Rather than have a huge engine running at the speed of the vehicle thus exhibiting extreme energy inefficiencies, a small engine is used that drives only a hydraulic pump. The small engine runs only infrequently for a short time and then at its most efficient speed. The output of the engine driven hydraulic pump feeds an energy storage system so that when the engine runs, it fills the energy storage system and then is turned off. The energy storage system consists of a conventional pneumatic/hydraulic accumulator and an energy wheel (Flywheel).

Contrary to the depreciation of battery performance with age as is the case in the battery hybrid vehicle, this energy storage system does not degrade and never has to be replaced.

The energy wheel also functions as a Control Moment Gyroscope to be used in preventing vehicle roll over.

The energy that has been expended in operating the vehicle is replaced by using the engine operating a hydraulic pump, and also by causing the wheel drive motors to be configured as hydraulic pumps. As hydraulic pumps they recover the kinetic energy of the motion of the vehicle both during braking and also during decelerations. Further energy is developed by a hydraulic energy recovery system the derives its energy from the bumps in the road and that energy is added to the storage.

Energy to propel and steer the vehicle is derived from the storage system until it is exhausted at which time the engine comes on and in a very short time refills the storage. On the average, the engine runs less than 10 % of the time the vehicle is operating.

In the conventional vehicle, if the operator turns at a high speed, the vehicle may roll over. In the present invention, if the operator turns at a speed that would cause the vehicle to turn over, the inertial stiffness of the Control Moment Gyroscope prevents the vehicle from turning over. If a blowout or icy road were to occur, the vehicle would immediately initiate an unwanted turning action. The Rate Gyroscope senses the uncommanded turn and causes the differential drive wheel speed to be altered to prevent the vehicle from turning. Those actions are automatic and occur so fast that no operator action is required.

The control of the vehicle is accomplished by operator input commands to a central computer system. The entire control of the vehicle is accomplished by operator commands being translated by the computer into vehicle commands to be carried out in accordance with vehicle physical parameters. The vehicle control system is triplex and fail operational. Being fail operational is defined as having the system allow the vehicle to operate without degraded performance in the event of a component failure. In practice the vehicle is allowed to operate after a failure only long enough to get to safety.

Having a computer controlled control system allows remote operation of the vehicle. Using that feature, military vehicles carrying armament or surveillance equipment could be directed without an onboard operator. Cargo could be transported according to a preplanned program and in the ultimate, public transportation might use this capability. Air traffic control directs the operation of the world's airways. Using the same techniques, ground traffic control could manage the use of the vehicle of the present invention in transporting people or goods within a geographical roadway system.

Not only is the vehicle of the present invention significantly more fuel efficient, it is simple to manufacture, requires minimum maintenance, body styles are easily changed and it can be remotely operated. In addition countless lives will be saved by the ability to prevent roll over and spin out accidents.

### DRAWINGS

FIG. 1 is a schematic representation of a four wheeled vehicle platform showing the presence of the component parts.

FIG. 2 shows the schematic details of a castoring wheel.

FIG. 3 shows the schematic details of a driving wheel.

FIG. 4 shows the schematic details of the engine compartment.

FIG. 5 is a schematic block diagram of the hydraulic distribution system.

FIG. 6 is a depiction of the locus of the mean inertial chord.

### DETAILED DESCRIPTION

The vehicle of this system is a platform upon which all the components of the system as well as a cargo compartment are mounted. The cargo compartment may be of any configuration and is not considered a part of this invention. The cargo compartment could be the body of a passenger car or truck or a mount for any number of active elements. In a military application, armament might be the cargo. Alternatively surveillance equipment could be the cargo. Freight could be the cargo. The choice as to the use of the platform of this system is at the discretion of the user.

The preferred embodiment allows the vehicle to operate by driving the rear wheels and allowing the two front wheels to castor. Another embodiment would allow the vehicle to operate by driving the front wheels and allowing the two rear wheels to castor. Yet another embodiment would allow the vehicle to operate by driving the rear wheels and having only one castoring front wheel. Yet another embodiment would allow the vehicle to operate by driving the front wheels and having only one castoring rear wheel.

Having the steering wheel turn the two front wheels of the vehicle in order to generate the turn controls the conventional passenger vehicle steering. Because of that convention, the preferred embodiment and the description that follows is based upon having the vehicle driven by the rear wheels and allowing the two front wheels to castor. The system would function equally as well in any of the other embodiments.

Ancillary parts, such as a gas tank, exhaust system, hydraulic filters and others, which are conventionally needed to operate a motorized, wheeled vehicle, are not shown nor discussed as their requirement is considered to be obvious.

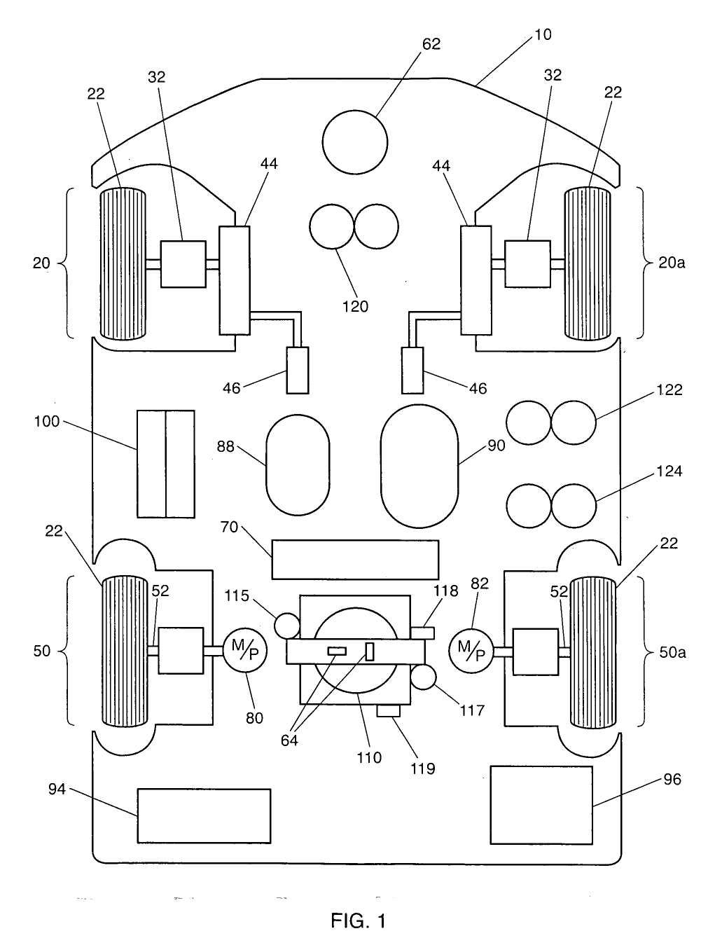

FIG. 1 identifies the presence of all the major components of the system. The location in the schematic block diagram is not representative of the actual location of the parts within the Frame 10. The location of the parts is established by the weight contribution of each of the components to the location of the center of gravity of the vehicle.

Frame 10 supports all the components of the system as well as the cargo compartment that is mounted upon the frame to make the vehicle useable. The sole purpose of the platform of the present invention is to carry useful cargo. Frame 10 is a conventional vehicle frame structurally capable of providing support for the components of the system and the appropriate cargo.

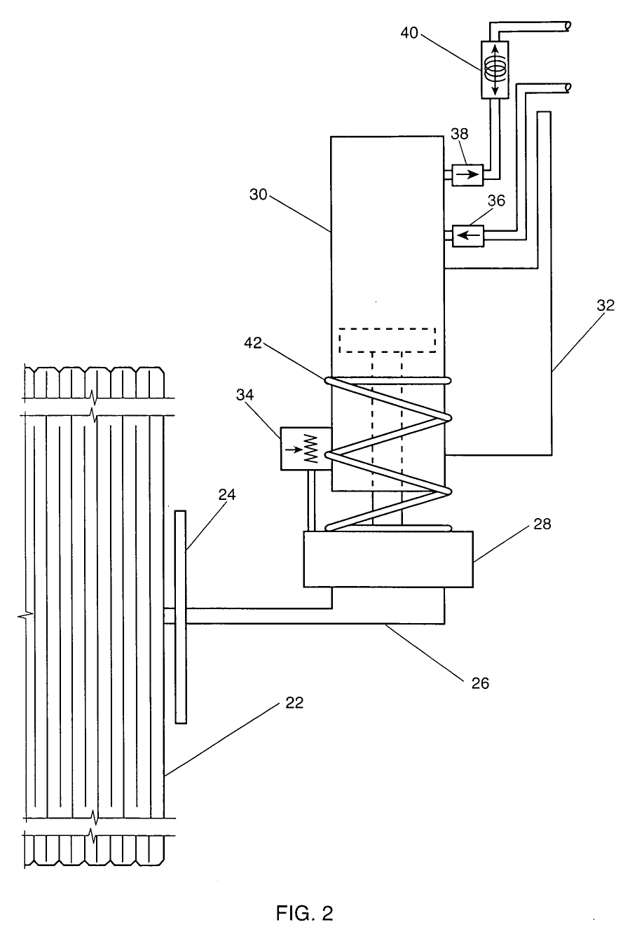

Castoring wheel 20,20a is made up of component parts shown in FIG. 2 Castoring wheel 20a is a mirror image of Castoring wheel 20 and hereinafter will not be separately designated. Referring now to FIG. 2, Castoring wheel 20 is comprised of a conventional vehicle wheel and tire with its associated bearings upon which is mounted a conventional Electric brake 24. Axle mount 26 carries the portion of the weight of the vehicle that is imposed upon Castoring wheel 20. That portion of the vehicle weight is developed by the location of the center of gravity of the vehicle. The total weight of the vehicle is shared by all the wheels with each wheel carrying the weight apportioned to it by the location of the center of gravity of the vehicle. That weight will be called the “existing weight” in further descriptions.

The existing weight of the vehicle is imposed upon Thrust bearing 28. Thrust bearing 28 functions to allow Castoring wheel 20 to castor appropriately without causing the piston of a conventional Hydraulic cylinder 30 to rotate. The piston of Hydraulic cylinder 30 is restrained from rotation since conventionally it is not designed to rotate while in use. While a hydraulic cylinder incapable of rotating is shown, other embodiment of this invention may have a hydraulic cylinder which is designed to rotate. The existing vehicle weight is transferred to Hydraulic cylinder 30 through Mount 32. Mount 32 carries the existing weight of the vehicle to the body of Hydraulic cylinder 30. Spring 42 allows the piston with Hydraulic cylinder 30 to deflect an amount depending upon the existing weight of the vehicle that is imposed upon that particular Castoring wheel 20. Typically for a normal existing vehicle weight Spring 42 is designed to deflect half its normal excursion while the vehicle is at rest and on level ground.

Deflection sensor 34 measures the amount of deflection of Hydraulic cylinder 30 with its associated Spring 42. Deflection sensor 34 is a set of three sensors operating independently to provide redundancy. Hydraulic cylinder 30 is filled with hydraulic fluid above its piston, that fluid having been drawn through In-flow checks valve 36. The source of the fluid being transferred will be discussed in later detail. As the existing weight of the vehicle is imposed upon Castoring wheel 20, Hydraulic cylinder 30 deflects downward and that hydraulic fluid is compressed. As it is compressed the fluid cannot flow through In-flow check valve 36 since it is designed to prevent flow in that direction. It can pass through Out-flow check valve 38 and does so until it reaches Flow control valve 40. Flow control valve 40 is a conventional hydraulic flow control valve, which controls the rate of fluid flow in response to an electrical signal. The flow of hydraulic fluid through Flow control valve 40 is managed by an electrical signal from Computer 100. The action taken by Computer 100 and Flow control valve 40 will be discussed in later detail.

The deflection of Hydraulic cylinder 30 therefore is controlled by a combination of the spring constant of Spring 42 and the action of Computer 100 in controlling the function of Flow control valve 40.

Now referring to FIG. 1, Mount 32 is connected to Reverse mount assembly 44 which carries the existing weight of the vehicle to Mount 32 but also allows for Castoring wheel 20 to be canted either forward or aft. Reverse mount 44 is a mechanism designed in accordance with good engineering practice and requires no special consideration. In order to provide the necessary force to cause Castoring wheel 20 to perform castoring action the entire Castoring wheel 20 is canted. If the vehicle is moving forward, Castoring wheel 20 is canted aft. If the vehicle is moving in reverse Castoring wheel 20 is canted forward. Fwd Reverse actuator 46 is attached to Reverse mount 44. Fwd Reverse actuator 46 is a conventional hydraulic cylinder that contains a piston driven by hydraulic pressure. The motion of that piston moves appropriate mechanics in Reverse mount 44 to cause the cant of Castoring wheel 20 to be in the required position.

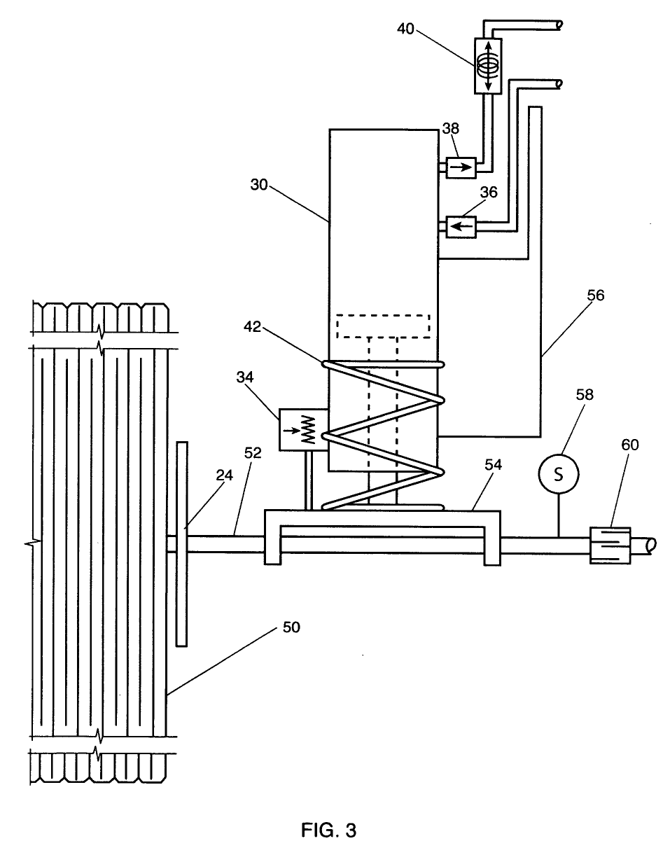

Now referring to FIG. 3. Drive wheel assembly 50 (50a) is a conventional wheel and tire with its associated bearings to which is attached Electric brake 24. Drive wheel assembly 50a is a mirror image of Drive wheel assembly 50 and hereinafter will not be separately designated except as related to Left Drive motor pump 80 and Right drive motor pump 82. Drive wheel assembly 50 is conventionally connected to Drive axle 52 so the motion of Drive axle 52 rotates Drive wheel assembly 50. Bearing assembly 54 supports the existing weight of the vehicle via the piston of Hydraulic cylinder 30. The existing weight of the vehicle is transferred to the body of Hydraulic cylinder 30 through Drive wheel mount 56. Drive wheel mount 56 is rigidly attached to Frame 10. Spring 42 allows the piston of Hydraulic cylinder 30 to be positioned as a function of the existing weight of the vehicle that is imposed upon that particular Drive wheel assembly 50. The piston of Hydraulic cylinder 30 and Bearing assembly 54 are restrained from rotating but are free to move vertically. Typically if operating independently of the control of Flow valve 40, for a normal existing vehicle weight Spring 42 is designed to deflect half its normal excursion while the vehicle is at rest and on level ground. Drive wheel speed sensor 58 is a set of three sensors each of which measures the rotational speed of Drive axle 52 Three sensors are used to provide redundancy required by the vehicle control system.

Deflection sensor 34 measures the vertical position of Drive wheel assembly 50. Deflection sensor 34 is a set of three sensors to provide redundancy. Hydraulic cylinder 30 is filled with hydraulic fluid above its piston, that fluid having been drawn through In-flow check Valve 36. The source of the fluid being transferred will be discussed in later detail. As the existing weight of the vehicle is imposed upon Drive wheel assembly 50, Hydraulic cylinder 30 deflects downward and that hydraulic fluid is compressed. As it is compressed the fluid cannot flow through In-flow check valve 36 since it is designed to prevent flow in that direction. It can pass through Out-flow check valve 38 and does so until it reaches Flow control valve 40. Flow control valve 40 is a conventional hydraulic flow control valve that controls the rate of fluid flow in response to an electrical signal. The flow of hydraulic fluid through Flow control valve 40 is managed by an electrical signal from Computer 100. The action taken by computer 100 and the disposition of the fluid having been transferred through Flow control valve 40 will be discussed in later detail.

The vertical deflection of Hydraulic cylinder 30 therefore is controlled by a combination of the spring constant of Spring 42 and the action of Computer 100 in controlling the function of Flow control valve 40.

Drive axle 52 is connected to Universal joint 60. Universal joint 60 is a conventional constant velocity universal joint that provides the ability to continuously transmit power to Drive wheel assembly 50 while Drive wheel assembly 50 moves vertically in response to perturbation in the road surface.

Now referring to FIG. 1 Drive axle 52 of the appropriate Drive wheel assembly is connected conventionally through Universal joint 60 to the output shaft of the appropriate Drive motor pump.

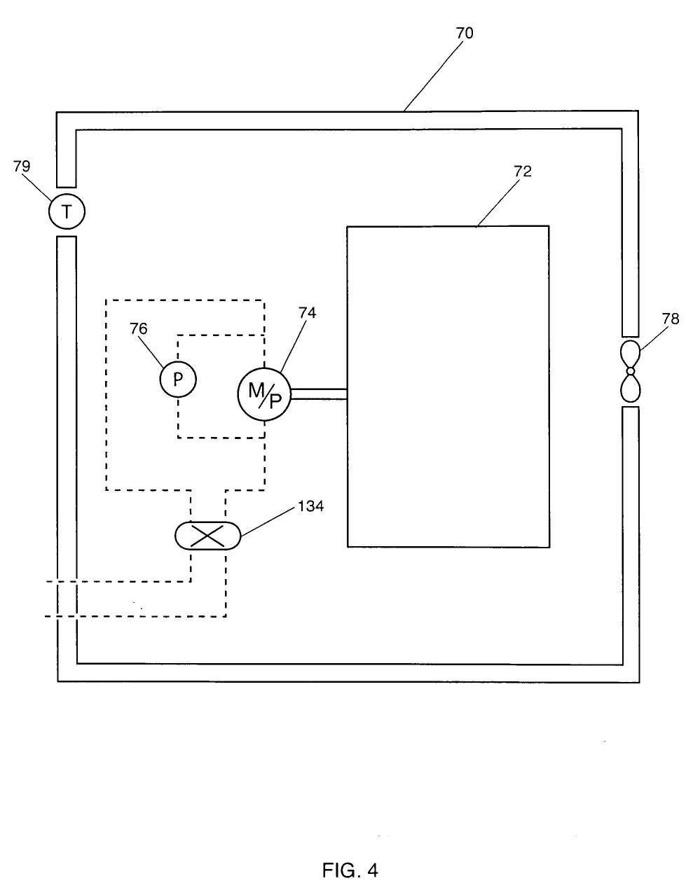

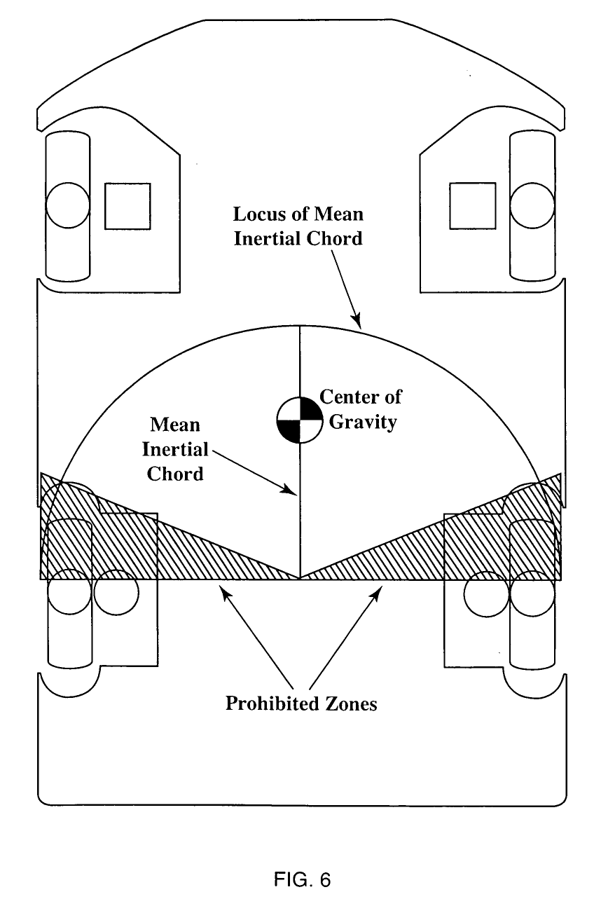

Now referring to FIG. 4. Engine compartment 70 is shown in FIG. 4 Engine compartment 70 is constructed of a commercially available sound deadening material. Engine compartment 70 is rigidly mounted to Frame 10 in the appropriate location to assist with the location of the vehicle center of gravity of the vehicle and also to provide access to service Engine 72. Engine 72 is mounted within Engine enclosure 70. Engine 72 is a commercially available prime mover that may be an engine or motor with its output energy being derived from any fuel for which it is designed and capable of rotationally driving Engine motor pump 74. Engine motor pump 74 is a fixed displacement hydraulic pump capable of pumping the amount of hydraulic fluid representing the equivalent horsepower of Engine 72. Associated hydraulics lines are shown for reference with details of the hydraulic interconnects shown in FIG. 6. Engine motor pump 74 is conventionally connected to the output shaft of Engine 72. Pressure sensor 76 measures the hydraulic pressure across Engine motor pump 74. Fan 78 is electrically driven and mounts in an air inlet orfice to Engine compartment 70. It functions as required by conventional signals generated by Thermostat 79

Now referring to FIG. 1, Rate Gyro 62 is a set of 3 commercially available solid state Rate Gyroscopes mounted to Frame 10. Rate Gyro 62 measures the rate of turn of the vehicle. A set of three is required in order to provide redundancy for the senses used in the control system for the vehicle.

Surge tank 88 is a commercially available hydraulic accumulator. As an accumulator it has contained within it a volume of gas separated from the hydraulic fluid it contains by a flexible membrane. Functioning conventionally as an accumulator it stores energy in the pneumatic section. Energy is stored in Surge tank 88 by compressing the volume of gas. As hydraulic fluid is supplied to Surge tank 88 from the system energy sources the stored energy of Surge tank 88 increases. The hydraulic fluid pressure in Surge tank 88 represents the magnitude of the stored energy. Upon a requirement for energy to be used by the system, hydraulic fluid is ported appropriately from Surge tank 88 to the element of the system requiring energy.

Storage tank 90 is a commercially available reservoir from which all the hydraulic fluid used in the various applications is drawn and to which all the hydraulic fluid is returned.

Computer 100 is a redundant set of two identical commercially available computers and the electronic interface necessary to electrically connect the computers to their applications. The programming of Computer 100 uses conventional programming processes. The electronic interface circuitry associated with each computer processes the data inputs and outputs of the computers, formatting it appropriately for use. The circuitry is not unique and is configured in accordance with good engineering practice.

Accessories 94 are an accumulation of the interface circuitry required to allow the electrical functions of the cargo. Typically, if the cargo was a passenger car, the accessories could be air conditioning, lights entertainment and other accessories. Accessories 94 do not enter into the functions of the vehicle and are only identified as required elements in the overall system. Electrical junction box 96 contains the necessary electrical circuitry to serve the requirements of the vehicle. Components include dual batteries monitored by Computer 100, dual DC to AC Inverters also monitored by Computer 100. Additional components include conventional interconnect and circuit protection devices necessary to safely distribute the on board electrical energy.

Control moment gyro 110 is an energy wheel comprising a wheel spinning in the horizontal plane, gimbaled in the pitch axis of the vehicle and elastically mounted in the roll axis. The energy wheel, pitch axis and roll axis gimbals are considered an integral part of Control moment Gyro 110 and are not separately designated. When Control moment gyro 110 is erected in a position with the energy wheel spinning in the horizontal plane excursions of the vehicle in pitch and roll are measured by conventional Roll angle sensor 115 and Pitch angle sensor 117. Pitch angle sensor 117 measures the existing angle between the plane of the rotating wheel of Control moment gyro 110 and the plane of the roll axis gimbal. Roll axis sensor 115 measure the existing angle between the plane of the roll angle gimbal and Frame 10 of the vehicle. The wheel of Control moment gyro 110 hereinafter referred to as a gyroscopic wheel, is a conventional flywheel capable of operating at the required rotational speed. Control moment gyro 110 functions as an energy storage medium as well as a gyroscope. The pitch axis gimbal is connected to the spinning gyroscopic wheel so that its use allows the wheel of the gyroscope to remain inertially in position as the vehicle pitches. The pitch axis gimbal is connected to the roll axis gimbal. The roll axis gimbal is connected to Frame 10 thus translating the inertial characteristics of the gyroscope to the Frame 10. The mount of the roll axis gimbals, using normal good engineering practice is designed to allow a small but cushioned roll motion of the vehicle until at a preset roll limit allows no further roll gimbal excursion. At the limit of excursion of the roll mount, the dynamic action of Frame 10 is imposed directly upon the inertial stiffness of the Gyroscope. Spacecraft use the inertial stiffness of gyroscopes to generate a turning moment used to control the attitude of the spacecraft. If an attitude change is desired, the spacecraft uses the inertial stiffness of the gyroscope as a foundation against which forces are imposed to generate a turning moment. That turning moment results in an alteration of the attitude of the spacecraft. For that reason it is called a Control Moment Gyroscope. Control moment gyro 110 provides that function to this vehicle in preventing a roll over accident.

Control moment gyro 110 is maintained in an erect position by the use of a conventional gyroscope erection process. The erection process uses hydraulic actuators imposing force on the gimbals of Control moment gyro 110 to ensure that its gyroscopic position is vertical. Those hydraulic actuators may be locked in position and as such the hydraulic actuator related to the pitch gimbal is denoted as Pitch gimbal lock 118. The hydraulic actuator used in erecting the roll axis of Control moment gyro 110 is denoted as Roll gimbal lock 119 Control moment gyro accelerometers 64 measure any vibration that might arise from a mechanical anomaly having occurred to Control moment gyro 110. The two accelerometers 64 are mounted orthoganlly on the pitch axis gimbal. Signals from Control moment gyro accelerometers 64 are sent to Computer 100. If Computer 100 senses an abnormal level of acceleration being derived from Control moment gyro accelerometers 64, Computer 100 applies action to stop the rotation of the wheel of Control moment gyro 110 and to prohibit further operation of the vehicle.

Electric motor pump 120 is used to fill the energy storage system of the vehicle by taking energy from a source external to the vehicle. Electrical motor pump 120 comprises two elements, one element being an electric motor; the other element being a hydraulic pump driven by the electric motor. When energized, Electric motor pump 120 is used to develop the hydraulic energy necessary to fill the energy storage system of the vehicle.

Generator 122 is used to generate the electrical energy necessary to operate the vehicle. Generator 122 comprises two elements; one element being a hydraulic motor deriving its energy from the vehicle hydraulic system, the other element being a conventional electrical generator with is associated controls. When energized Generator 122 provides the necessary electrical energy for use in the operation of the vehicle and the added requirements of the cargo, as serviced by Accessories 94.

Air conditioning motor compressor 124 is used to generate the required cooling for use as necessary in functions of the vehicle as well as cooling of the cargo. Air conditioning motor compressor 124 comprises two elements; one element being a hydraulic motor that derives its energy from the vehicle hydraulic system, the other element being a conventional air-conditioning compressor and associated controls. When energized Air conditioning motor compressor 124 provides the necessary cooling for the vehicle and cargo.

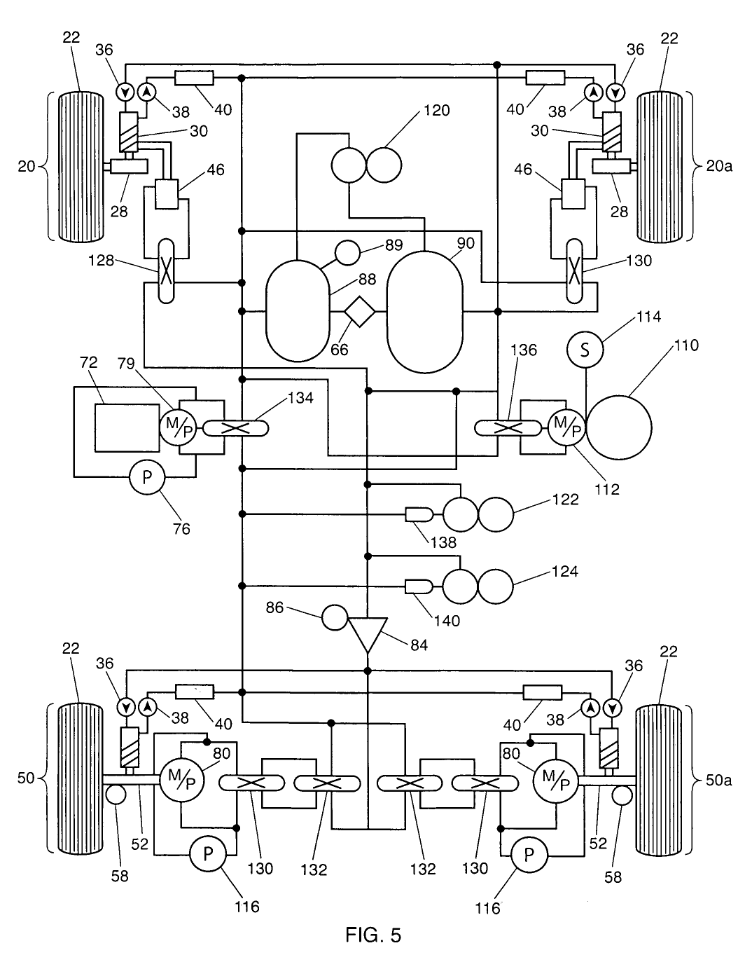

Now referring to FIG. 5 the Hydraulic system of the vehicle is shown as a schematic block diagram in FIG. 5. Conventional items such as filters, hydraulic fuses, redundant duplicate lines and others, which are required but are not unique and are obvious, are not shown.

Castoring wheel 20, 20a containing Hydraulic cylinder 30 moves upward in the vertical plane as a result of encountering a bump in the road surface. As it does, hydraulic fluid contained in the cylinder of Hydraulic cylinder 30 is compressed by the upward motion of the piston of Hydraulic cylinder 30 and is fed through Outflow check valve 38 and Flow control valve 40 to Surge tank 88. Inflow check valve 36 is closed preventing fluid transfer to Storage tank 90. Upon having passed the bump in the road, Castoring wheel 20, 20a moves down ward being driven by Spring 42. Hydraulic fluid is drawn into the cylinder of Hydraulic cylinder 30 through Inflow check valve 36 having been derived from Storage tank 90. Outflow check valve 38 is closed preventing fluid from entering the cylinder from that source.

If reverse action of the vehicle is required Fwd reverse actuator 46 is energized to move the cant of Castoring wheel 20, 20a to the reverse position. Fwd reverse shuttle 130 is commanded to port fluid derived from Surge tank 88 to Fwd reverse actuator 46 so that the piston of Fwd reverses actuator 46 moves to cause Castoring wheel 20,20a to move to the reverse castoring position. Fluid from the low-pressure side of Fwd reverse actuator 46 is returned to Storage tank 90. If forward motion of the vehicle is required Fwd reverse shuttle 130 is configured to port fluid appropriately to Fwd reverse actuator 46 so the piston of Fwd reverse actuator 46 moves to cause Castoring wheel assembly 20,20a to the forward position. If the energy storage system of the vehicle is to be filled from a source of energy external to the vehicle, Electric motor pump 120 is used. Electrical energy derived from the power grid causes the electric motor of Electric motor pump 120 to drive the hydraulic pump of Electric motor pump 120 to draw fluid from storage tank 90, pressurize it and deliver the pressurized fluid to Surge tank 88.

In the operation of the vehicle, if the energy storage system of the vehicle has been reduced to point that it needs to be recharged, Engine 72 is started. Hydraulic fluid pressurized by Engine 72 driving Engine motor pump 74 is fed to Surge tank 88.

Control moment gyro 110 provides the vehicle's primary energy storage. Kinetic energy is stored the spinning wheel of Control moment gyro 110. The rotational speed of the wheel and therefore its energy level is measured by Gyro Wheel speed sensor 114. When Computer 100 determines that the energy level stored in Control moment gyro 110 has reached its lower preset limit additional energy is acquired. Computer 100 configures Gyro motor pump shuttle 136 to cause Gyro motor pump 112 to function as a motor. Pressurized hydraulic fluid from Surge tank 88 is fed to Gyro motor pump 112 functioning as a motor to increase the rotational speed of the wheel of Control moment gyro 110. When the wheel speed of Control moment gyro 110 has reached its upper preset limit, Gyro motor pump shuttle 136 is reconfigured to cause Gyro motor pump 112 to be configured to function as a pump. The displacement of Gyro motor pump 112 is thereafter modulated as necessary to deliver the stored energy of Control moment gyro 110 to the system.

Generator 122 provides electrical energy to the systems in the vehicle and the cargo.

Computer 100 monitors the energy level in the electrical system and when additional energy is needed Computer 100 energizes Generator hydraulic switch 138 to cause the hydraulic motor of Generator 122 to drive the electrical generator of Generator 122 until Computer 100 determines no further need for additional electrical energy. Computer 100 then turns off Generator hydraulic switch 138.

Air conditioner motor compressor 124 provides air conditioning to the cargo when required. Sensors in the cargo send the required signal to Air-conditioner hydraulic switch 140 to cause the hydraulic motor of Air conditioner compressor 124 to drive the compressor of Air conditioner compressor 124. When sensors in the cargo determine no further air conditioning is required they send the appropriate signal to Air conditioner hydraulic Switch 140.

If reverse action of the vehicle is required Fwd reverse shuttle 130 is configured to cause Drive motor pump 80 and Drive motor pump 82 to turn in the reverse direction. If motion of the vehicle is required in the reverse direction, Drive motor pump shuttle 132 is configured to cause Drive motor pump 80 and 82 to function as motors using pressurized hydraulic fluid from Surge tank 88, with the returning hydraulic fluid being sent to Storage tank 90. Computer 100 is phased to control actions of the vehicle while in reverse motion.

If forward motion of the vehicle is required Fwd Reverse shuttle 130 is configured to cause Drive motor pumps 80 and 82 to turn in the forward direction. If motion of the vehicle is required in the forward direction Drive motor pump shuttle 132 is configured to cause Drive motors 80 and 82 to function as a motor using pressurized fluid from Surge tank 88 and with the returning fluid being sent to storage tank 90. Computer 100 then commands the required action.

If the vehicle is in motion in either direction, or if the vehicle is stopped and a braking or deceleration signal is applied, Computer 100 sends a signal to Drive motors 80 and 82 to reduce the drive rotational force to zero. Drive wheel pressure sensor 116 measures the pressure drop across Drive motors 80 and 82. When the pressure sensed by Drive wheel pressure sensor 116 reaches zero, Computer 100 sends a signal to Drive motor pump shuttle 132 to configure Drive motor pumps 80 an 82 to function as pumps. Kinetic energy stored in the moving vehicle now drives Drive motor pumps 80 and 82 functioning as pumps to derive hydraulic fluid from Storage tank 90, pressurize it and send it to surge tank 88. The amount of the hydraulic fluid being transferred is controlled by Computer 100 thus determining the amount of braking or deceleration that results.

Wheel speed sensor 58 measures the rotational speed of wheels 50 and 50a.

Drive wheel assembly 50 or 50a with associated Hydraulic cylinder 30 moves upward in the vertical plane as a result of encountering a bump in the road surface. As it does, hydraulic fluid contained in the cylinder of Hydraulic cylinder 30 is compressed by the upward motion of the piston of Hydraulic cylinder 30 and is fed through Outflow check valve 38 and Flow control valve 40 to Surge tank 88. Inflow check valve 36 is closed preventing fluid transfer to Storage tank 90. Upon having passed the bump in the road, Drive wheel assembly 50 or 50a moves downward being driven by Spring 42. Hydraulic fluid is drawn into the cylinder of Hydraulic cylinder 30 through Inflow check valve 36 having been derived from Storage tank 90. Outflow check valve 38 is closed preventing fluid from entering the cylinder from that source

### Functional Description of the Preferred Embodiment

The vehicle of the present invention is a self-propelled vehicle that functions in the same manner as a conventional vehicle while performing similar actions. Conventionally a passenger vehicle is operated by a driver accustomed to using a steering wheel, throttle and brake. In the present invention, the onboard operator may use the same practice. Additional features allow operation of the vehicle to be directed from pre-planned programs or from signals emanating elsewhere. The configuration of the system ensures that an onboard operator uses conventional control practices without the need for additional training Signals derived from pre-planned programs or emanating from remote sources are configured appropriately the match the practice of an onboard operator.

In practice, an operator initiates an action and follows with the magnitude and rate of the required action. As an example in the conventional vehicle, the operator moves the foreword reverse lever to the reverse position, which reconfigures the transmission to cause the vehicle to be able to move in reverse. The operator then moves the throttle from zero position to a position representing the speed desired. The vehicle system responds by increasing the energy derived from the engine to accelerate the vehicle to the speed represented by the throttle position. To stop the motion of the vehicle the operator returns the throttle to the zero position and applies braking action. When the throttle is returned to the zero position, the engine is reduced to idle speed. If the vehicle is moving faster than idle speed, the engine is back driven by the inertia of the vehicle. Essentially the vehicle is being restrained by the cylinder compression forces of the engine. The operator is accustomed to experiencing compression drag from the engine and is trained to accept it in normal driving practice. The amount of braking action follows resulting from the friction of the brakes being imposed on the driving wheels.

In the present invention the same operator practice is followed. All commands are presented to Computer 100. Each command includes the requirement to configure the system appropriately followed by the magnitude and rate of the command. As an example, if the operator moves the forward reverse lever (switch) to the reverse position, Computer 100 configures the hydraulic shuttles and the Drive motor ports to cause the vehicle to move in reverse. The operator then moves the throttle from the zero position to a position representing the desired vehicle speed. Computer 100 increases the displacement of the drive motors increasing the flow of hydraulic fluid to accelerate the vehicle to the speed represented by the throttle position. To stop the vehicle, the operator returns the throttle to the zero position and applies deceleration action. Upon the throttle reaching zero position, Computer 100 configures the hydraulic shuttles and drive motor ports to configure the drive motors as pumps. Simultaneously Computer 100 applies a small bias signal to the displacement of the drive motors functioning as pumps. The magnitude of that bias is equivalent to the compression drag of the conventional engine while at idle. Upon the application of braking action by the operator, Computer 100 increases the displacement of the drive motors functioning as pumps in an amount and at the rate that braking was applied. The magnitude of the braking action imposed on the vehicle results from the volume of hydraulic fluid being pumped. If the operator had only wished to coast to a stop but not brake, the drive motors responding to the bias signal would recover the kinetic energy of the car while coasting to a stop.

There are four major functions of the vehicle. They are: propulsion and braking, steering, suspension and energy management. In the description of the operation each function will be described independently of the other. As an example, propulsion and braking will be described having no existing vehicle steering turn requirement.

The vehicle functions in response to discrete input commands. Each input command results in discrete actions being taken by elements of the system. All input commands are directed to Computer 100. Computer 100 with is associated interface electronics processes the input command and delivers a Computer command to the required action element of the vehicle. The processing takes into account the existing configuration of the vehicle As an example, if the gross weight of the vehicle was large and the center of gravity far foreword in the vehicle frame, Computer 100 would generate a Computer command to the drive wheels accordingly. If the gross weight of the vehicle was small and the center of gravity near the center of the vehicle frame, Computer 100 would generate a Computer command in accordance with those parameters. Those two commands to the drive wheels would differ in both magnitude and rate. Computer commands generated by Computer 100 are formed in accordance with the dynamic requirements of the vehicle.

The Computer commands related to the same action element of the system differ in magnitude and rate for various configurations of vehicle. The Computer commands for a vehicle with the cargo being a passenger car are different from the computer commands for a vehicle with the cargo being an armament. The computer commands are different for each total vehicle configuration. The program to develop the required commands is installed in Computer 100 for each total vehicle configuration.

To control the operation of the vehicle input commands from the operator are required. The first motion of a sensor moved by the operator in issuing the command causes Computer 100 to initiate actions to cause the required configuration by the action elements. As an example, upon the first motion of the brake pedal by an on board operator, Computer 100 configures the drive motor shuttles to be configured to cause the drive motor pumps to be configured as pumps. The shuttles move in response to the signal from the computer typically in less than 25 milliseconds. A millisecond is one thousandth of a second. Upon receiving the signal from Computer 100 to alter the displacement of the drive motor pump, that displacement takes place within an average of less than 60 milliseconds and occurs simultaneously with the action of the shuttle. The typical reaction time of a human to perform the same operation is 180 milliseconds to recognize the need for action and another 60 milliseconds to employ the action. Therefore the action of the shuttles and motor pumps is much faster than the reaction of a human.

The magnitude and rate at which the input command is applied is used by Computer 100 to develop the magnitude and rate of the command it issues as a result. Computer 100, using the existing physical parameters of the vehicle varies the magnitude and rate of the command it issues to accommodate the physical parameters of the vehicle. As an example if the operator pushes hard and fast on the throttle, the computer uses data that identifies the gross weight and center of gravity of the vehicle and a preset average tire to road surface friction level to develop the magnitude and rate of the command it issues. That resulting computer command is such that the drive wheels accelerate at a maximum rate demanded by the throttle action without spinning or skidding.

Each time an input command is issued, the same discrete actions occur. To make the description of the operation of the vehicle easier to understand, those commands and the resulting discrete actions are listed and given reference numbers. Thereafter, when necessary in describing an operation and the action that is required, it will be identified with the name and reference number of the command. It is recognized that the discrete command listed results from the first motion of the input sensor in the case of an onboard operator. In the event of a remote or programmed signal, the discrete action occurs with the receipt of the command. Certain discrete actions are initiated by switches and are identified.

The discrete actions are listed:

Start up command 200C:
Self-test program is performed.
Hereinafter when Engine 72 is started the following sequences occur:
   Engine motor pump shuttle 134 is configured to cause Engine motor pump 74 to function as a motor.
   Gyro motor pump shuttle 136 is configured to cause Gyro motor pump 112 to function as a motor.
   Fuel flow and ignition appropriate for the engine type being employed is provided
   Pressure sensor 76 measures the pressure drop across Engine motor pump 74. When Engine 72 starts, as it begins to run, it reduces the load on Engine motor pump 74 until that pressure drops to zero. At that time Computer 100 configures Engine motor pump shuttle 134 to cause Engine motor pump 74 to function as a pump.
Control moment gyro 110 erection program is performed. Using conventional liquid level gravity sensing accelerometers (not shown), Computer 100 applies the necessary action to Roll gimbal lock actuator 119 and Pitch gimbal lock actuator 118 to precess Contol moment gyro 110 to a level attitude.

Speed command 201C:
If the existing speed of the vehicle is such that increasing or constant energy is required to meet the requirements of Speed command 201C, Drive motor pump shuttles 132 are configured to cause Drive motor pumps 80 and 82 to function as motors If the existing speed of the vehicle is such that a restraint is required to reduce the speed of the vehicle to meet the requirements of Speed command 201C, Drive motor pump shuttles 132 are configured to cause Drive motor pump 80 and 82 to be configured as pumps.

Turn command 202C:
If the existing speed of the vehicle is such that increasing or constant energy is required to meet the requirements of Speed command 201C, Drive motor pump shuttles 132 are configured to cause Left drive motor pump 80 and Right drive motor pump 82 to function as motors. If the existing speed of the vehicle is such that a restraint is required to reduce the speed of the vehicle to meet the requirements of Speed command 201C, Drive motor pump shuttles 132 are configured to cause Left Dive motor pump 80 and Right Drive motor pump 82 to be configured as pumps. Computer 100 is phased so that the application of motor pump displacements to meet the requirements of Turn command 202C results in the application of motor pump displacements to correctly control the differential rotational speed of the drive wheels.

Brake command 204C:
(Drive brake command 204C maybe activated only if the vehicle speed is zero)
Drive motor shuttle 132 is configured to cause Drive motor pumps 80 and 82 to function as pumps.

Reverse command 206C:
(Reverse command 206 C may be activated only if the vehicle speed is zero)
Fwd reverse shuttle 130 is configured to cause Drive motor pumps 80 and 82 to function in the reverse rotation.
Drive motor pump shuttle 132 is configured to cause Drive motor pumps 80 and 82 to function as motors.
Actuator fwd reverse shuttle 128 is configured to extend the piston of Fwd reverse actuator 46 thus causing the cant of Castoring wheel 20 and 20a to be in the reverse position.
Computer 100 is phased to accommodate the required calculations associated with the reverse motion of the vehicle.

Cruise control command 208C (switched)
Computer 100 functions to maintain the speed of Drive motor pumps 80 and 82 at the rate of rotation existing at the time Cruise control command 208C was issued.

Air conditioning on command 210C (switched)
Air conditioner hydraulic switch 140 is turned on to cause Air conditioner motor compressor 124 to function.

Parking brake command 212C (switched)
(Parking brake command 212C may be activated only if the vehicle speed is zero).
Drive motor pump shuttle 132 is configured to cause Drive motor pumps 80 82 to function as pumps.
Parking brake valve 84 is closed.

Assume that the vehicle is at rest, having been at rest for an indefinite period of time.

When it is desired to operate the vehicle, the first action is to activate the system using an initiation command or in the case of an onboard driver, typically, an ignition key. Start up command 200C is issued.

Immediately, Computer 100 initiates a self-test program that tests the condition of all the elements of the system that are required for safe operation. There are conventional methods to perform self-tests using artificial stimuli and evaluating the results. The tests require only a short time to complete and the operator is unaware of the fact that the tests are in progress. The successful completion of the self-test allows the initiation procedure to continue.

Data from Deflection sensor 34 of all four wheels is sent to Computer 100. Flow control valve 40 on all wheels is set to provide the minimum flow rate restriction. Pressure sensor 89 measures the existing pressure in Surge tank 88. Using that data Computer 100 determines the gross weight and center of gravity of the vehicle and adjusts the parameters of the computer program accordingly. By adjusting the parameters of the computer program, the vehicle performance resulting from input commands remains the same regardless of weight and center of gravity allowing the operator to always find the same vehicle performance. Given the capability of the control system, there is a physical limit within which the weight and center of gravity must remain. The location of that limit within the confines of Frame 10 of the vehicle is defined as the “mean inertial chord”. The mean inertial chord as associated with this vehicle is analogous to the “mean aerodynamic chord” associated with aircraft dynamics. The dimension of Mean inertial chord is determined by the ability of the control system to control the motion of the vehicle. Its locus is a section of a circle whose center is midway between the driving wheels and whose radius is the mean inertial chord. FIG. 6 is a schematic representation of the Mean Inertial chord. The center of gravity of the vehicle and the mean inertial chord are considered to be dynamic functional events and are labeled rather than being denoted by a reference number in FIG. 6. As long as the weight and center of gravity of the vehicle remains within the section of a circle representing the locus of mean inertial chord, the control system is able to safely manage the motion of the vehicle If the gross weight and Center of gravity were to exceed the physical limits represented by the mean inertial chord, the initiation process is terminated and the operator alerted. If the Gross weight and or center of gravity were to exceed the limits of the locus established by the mean inertial chord, there would be insufficient differential power derived from Drive wheel assembly 50 and 50a acting differentially to correctly control the longitudinal axis of the vehicle. In the basic vehicle design, normal loading would place the gross weight and center of gravity at a location somewhat foreword of the center of the half circle representing the locus of the mean inertial chord allowing normal accelerations to be commanded. If the gross weight and center of gravity were to be abnormally near the center of the semicircular section depicting the locus of the mean inertial chord, the ability to accelerate the vehicle would be compromised. A large input Speed command 201C would cause Drive wheel assemblies 50 and 50a to increase the rate of rotation at such a rate that the counter torque on the vehicle would cause Castoring wheels 20 and 20a to lift from the ground and ultimately could cause the vehicle overturn backwards. Computer 100 is programmed to recognize the acceptable magnitude of input Speed command signal 201C resulting from the existing location of the center of gravity and the existing gross weight. If the magnitude of Input signal 201C is so large as to cause the vehicle to overturn backwards, Computer 100 applies Pitch gimbal lock 118 to lock the pitch gimbal of Control moment Gyro 110 in its existing position. Roll gimbal lock 119 would also be energized to lock the roll gimbal so that a precessing force was not imposed on the gyroscopic function of Control moment gyro 110. By so doing, the force causing the vehicle to overturn backwards is imposed upon the gyroscopic stiffness of Control moment gyro 110. Gimbal locks 118 and 119 would remain in position until the speed of Drive wheel assembly 50 and 50a had reached a point that the counter rotating force on the vehicle is lessened to an appropriate magnitude. At that time, Computer 100 releases Gimbal locks 118 and 119. Again the vehicle is free to move within the established limits in the pitch and roll axes. If the center of gravity were to become too far to either side of the allowable locus of the mean inertial chord, insufficient weight would be imposed on either Drive wheel assembly 50 or 59a to allow the wheel to perform its required drive function without skidding. That area of FIG. 6 is denoted a prohibited area. If Computer 100 determines that the gross weight and center of gravity are located within those shaded areas, the vehicle is not allowed to operate.

Thereafter, every time all four wheels are not in motion at the same time, the gross weight and center of gravity is again calculated and again the parameters of the computer program are changed accordingly. Thus as fuel is burned or loads are added or deleted, the response of the control system remains unchanged. Should the loading of the vehicle cause either the gross weight or center of gravity to exceed locus of the mean inertial chord of the vehicle, Computer 100 automatically shuts down the vehicle.

When desired the operator issues Parking brake command 212C to close Parking brake valve 84. Parking brake valve 84 is a valve designed so that upon failure it defaults to the open position. Parking brake valve position sensor 86 monitors the position of Parking brake valve 84. Computer 100 only allows a response to Parking brake command 212C if Drive wheel speed sensors 58 are at zero speed. With a signal to Computer 100, Parking brake valve position sensor 86 confirms that Parking brake valve 84 is closed. If Parking brake valve 84 has failed and does not close, Computer 100 issues an alert but does not prohibit the function of the vehicle. As desired the operator removes Parking brake command 212C. Parking brake valve 84 then opens and Parking brake position sensor 86 confirms the open position with a signal to Computer 100. If Computer 100 does not receive that signal the vehicle is prohibited from operating.

In the preferred embodiment when the vehicle was turned off at the end of the last trip, Surge tank 88 was filled to capacity by having Engine 72 and associated hydraulics run until the capacity of Surge tank 88 was filled. Then Engine 72 was turned off. A circumstance could exist in which Control moment gyro 110 had been allowed to run down and therefore dissipate all its energy. When Startup command 200C is issued. Engine 72 starts. Surge tank 88 is full having been filled at the end of the last trip. With Engine 72 running, hydraulic pressure derived from Engine motor pump 74 is fed through Surge tank 88 to be applied to Gyro motor pump 112 functioning as motor. The wheel of Control moment gyro 110 builds up speed until it reaches the speed required by Computer 100, which represents its normal maximum energy capacity. Engine 72 is capable of driving the wheel speed of Control moment gyro 110 up to speed within the required time. Engine 72 is then turned off by Computer 100.

Another embodiment allows the vehicle at the end of the trip to be plugged into an electrical convenience outlet connected to the Electric grid. Computer 100 signals Electric motor pump 120 to operate to fill the entire energy storage system including Surge tank 88 and Control moment gyro 110. When the entire energy storage system has been filled to capacity, Computer 100 turns off Electric motor pump 120. At that time the vehicle is in an energy condition to be operated and requires no energy from Engine 72. Thereafter the vehicle may operate as long as the energy stored in the system remains, at the end of which time it must be refilled. If the trip were of short duration, sufficient energy may be available that no energy is required from Engine 72. If the trip is of such duration that the energy that had been derived from the electric grid is expended, the operation of the vehicle proceeds using energy derived from Engine 72.

In the preferred embodiment having been filled by Engine 72 at the end of the last trip Surge tank 88 being a conventional accumulator, contains energy in storage There may or may not be energy stored in Control moment gyro 100, depending upon the length of time the vehicle had been unused. Computer 100 measures the energy state of Control moment gyro 110. If the level of energy stored in Control moment Gyro 110 is below the established preset minimum Computer 100 initiates the procedure to start Engine 72.

Because Surge tank 88 was full at the time the startup action of the vehicle began, if the operator immediately demands that the car be driven, energy to perform that activity is derived from a combination of the energy stored in Surge tank 88 and the incoming energy from Engine 72.The time it takes to bring Control moment gyro 110 up to speed depends upon the energy drain demanded by the operator while the Control moment gyro 110 energy build up process is underway. When the energy stored in Control moment gyro 110 has reached its normal limit, and the energy in Surge tank 88 is also at capacity, Computer 100 shuts off Engine 72. Ongoing energy demands are satisfied from the energy storage system Had the energy storage level in Control moment gyro 110 been above a preset minimum level, the operation of the vehicle would proceed without the need to start Engine 72.

Drive motor pumps 80 and 82 and Control moment gyro motor pump 112 are variable displacement hydraulic motor pumps that may function either as a motor or a pump depending upon the port configuration. The torque and speed of the unit while functioning as a motor is controlled by the volume of fluid that it processes. The energy required to cause the unit to function as a pump results from the pump being driven by the motion of the wheels of the vehicle or the wheel of Control moment gyro 110. The volume of fluid being pumped represents the magnitude of the energy being transferred. The volume of fluid being transferred either as a motor or as a pump is a function of the displacement of the unit and is varied by an electrical signal derived from Computer 100.

At any time the vehicle is operating, signals from Control moment gyro accelerometers 64 are being fed to Computer 100. As long as the magnitude of those signals is below a preset acceptable level, Control moment gyro 110 is allowed to operate. If the magnitude of the signals emanating from Control moment gyro accelerometers 64 were to exceed the preset limit, Computer 100 initiates a sequence to stop the rotation of the wheel of Control moment gyro 110. Computer 100 sends a signal to Gyro shuttle 136 to configure Gyro motor pump 112 as a pump. Computer 100 increases the displacement of Gyro motor pump 112 to a maximum thus causing a maximum amount of fluid being derived from Storage tank 90 to be pumped The energy used to drive Gyro motor pump 112 as a pump causes the wheel speed of Control moment gyro 110 to decrease at the maximum rate until it stops. The hydraulic fluid pumped was fed to Surge tank 88 until it was filled to capacity. As the volume of fluid continued, the pressure in Surge tank 88 increased until reached the preset limit of Pressure relief valve 66. Pressure relief valve 66 is a normally closed valve that opens when exposed to an input pressure level above the level to which it has been set. Pressure relief valve 66 opened when the pressure in Surge tank 88 reached the limit of Pressure relief valve 66 and hydraulic fluid was ported to Storage tank 90. When the wheel speed of Control moment gyro 110 stopped, no further hydraulic fluid was pumped and Pressure relief valve 66 closed. Thereafter the vehicle is prohibited from operating

The vehicle may operate either in a foreword direction or in reverse. If reverse motion is desired, Reverse command 206C is issued. Propulsion, steering and braking are still accomplished except phased to accommodate the reverse motion of the vehicle. When foreward motion is again desired, Reverse command 206C is removed. Fwd reverse shuttle 130 defaults to a configuration that causes Fwd reverse actuator 46 to default to the retracted position. That action causes the cant of Castoring wheels 20,20a to revert to the foreward position. Computer 100 is rephrased to accommodate foreward motion in propulsion, braking and steering.

In the ensuing description, it is understood that the drive wheels refer to Drive wheel assemblies 50 and 50a, which are driven by Drive motor pumps 80 and 82 respectively

Assuming no turn command, when propulsion is required in either direction, the operator issues Speed command 201C. Speed command 201C when generated by an on board operator is the action of the throttle. Computer 100 sends a signal to Fwd reverse shuttle 130 to be configured in accordance with the direction established by the state of Reverse command 206C. If that command requires propulsion in the reverse direction, Fwd reverse shuttle 130 and the phasing of Computer 100 are configured accordingly. If the state of Fwd reverse command 206C is in the foreward direction, Fwd reverse shuttle 130 and the phasing of Computer 100 are configured accordingly. Speed command 201C is issued at a given rate and magnitude. Computer 100 using the physical parameters existing for that vehicle configuration, calculates that rate and magnitude of input signal to be a wheel speed to be reached within a calculated time. The signal generated by Computer 100 controlling the displacement of Drive motor pumps 80 and 82 causes hydraulic fluid to flow at a rate to accommodate that Computer command to Drive motor pumps 80 and 82. Both drive motor pumps functioning as motors, move Drive wheels 50 and 50a with the correct rotation and at the required rate of acceleration toward the required wheel speed demanded by Speed command 201C. Wheel speed sensor 58 measures the rotational speed of Drive wheels 50 and 50a. When the speed of Drive wheels 50 and 50a has reached the magnitude of Speed command 201C, the vehicle speed demanded by Speed command 201C has been reached as shown by the signal from Wheel speed sensor 58. Computer 100 directs the flow of hydraulic fluid to maintain that wheel speed. If an event occurs that causes a change in the force necessary to drive the vehicle at the commanded speed, the wheel speed changes. Wheel speed sensor 58 measures the resulting change in wheel speed. Its signal to Computer 100 causes Computer 100 to alter the flow of hydraulic fluid to Drive motor pumps 80 and 82 to cause them to return to the commanded speed. As Speed command 201C is changed by the operator, the vehicle reacts accordingly.

At any time brakes may be applied. Brake command 204C is issued. In the case of an onboard operator the position and the rate of application of the brake pedal represents the desired speed to which the vehicle is to be reduced and the rate at which the speed is to be reduced. Computer 100 uses that signal to determine the amount and rate of change of the displacement of Drive motor pumps 80 and 82 that is required to meet the vehicle action represented by the brake pedal motion. When the speed of Drive motor pumps 80 and 82 reaches the speed required as a result of the brake pedal position, having reached the desired speed, the operator removes Brake command 204C. The speed of the vehicle then reverts to the magnitude of Speed command 201C representing the throttle position. If the operator wants the vehicle to stop, the deflection of the brake pedal is such that the computer increases the displacement of Drive motor pumps 80 and 82 to a point that the speed measured by Wheel speed sensor 58 is zero. The rate and magnitude of the displacement signals is a function of the vehicle physical parameters resulting from the vehicle weight and center of gravity configuration at that time.

Circumstances could exist that require the use of Electric brake 24. If a total hydraulic failure were to occur, Computer 100 would initiate a program to implement Electric brake 24. Electric brake 24 would be applied as necessary to control the vehicle. The magnitude of the deflection of the brake pedal by an onboard operator is sent by Computer 100 to be the magnitude of the electrical current provided to Electric brake 24. In the case of other than an onboard operator; the braking signal would be the equivalent. Such a circumstance would exist if Surge tank pressure sensor 89 were to be at a minimum acceptable level as determined by Computer 100 and the energy regenerative process was non responsive. Alternatively a circumstance could arise such that only two wheel braking would be insufficient and the vehicle could not be brought to the commanded speed in accordance with the magnitude and rate of Brake command 204C That would be the case if the displacement of Drive motor pumps 80 and 82 were to be increased to a preset magnitude approaching maximum displacement, while Brake command 204C was in effect. Upon reaching that magnitude of displacement, Electric brake 24 is activated and the added braking provided by castoring wheels 20 and 20a would be added to the vehicle braking capability.

Assuming foreward motion, no turn command and no external forces such as variable winds, passing vehicles and others being exerted on the vehicle, the vehicle will continue at the speed of Speed command 210C. Should the driver wish to automatically continue that speed, Cruise control command 208C is issued. Computer 100, using input data from Wheel speed sensor 58 holds the wheel speeds constant, which results in a constant vehicle speed. Should a rising hill be encountered, extra energy is required to climb the hill. As the vehicle proceeds up the hill it tends to slow down. As it does, Wheel speed sensors 58 sends that signal to Computer 100. Computer 100 adjusts the displacement of Drive motor pumps 80 and 82 as required to maintain the speed of the vehicle in effect at the time of Cruise control command 208C. That adjustment causes more hydraulic fluid to be processed by Drive motors pumps 80 and 82 with the resulting increase in energy being expended.

If a downhill were to be encountered, the vehicle would tend to speed up. As it speeds up, the requirement for propulsion energy from Drive motor pumps 80 and 82 decreases. As the vehicle continues to increase its speed Computer 100 continues to reduce the displacement of Drive motor pumps 80 and 82 until finally no fluid is being used and the motors are contributing no energy. As less and less fluid was being processed, the hydraulic pressure drop across the motor declines until at the time there is no fluid being used the pressure drop across the motor is zero That pressure drop is measured by Drive wheel pressure sensor 116 and its data is sent to Computer 100. When the pressure drop measured by Drive wheel pressure sensor 116 reaches zero, Computer 100 reconfigures Drive motor pump shuttles 132 to cause Drive motor 80 and 82 to be configured as pumps. Now functioning as pumps, they perform a speed reducing force on the vehicle as it proceeds down the hill. In order to control the speed of the vehicle to be that existing at the time of Cruise control command 208C, Computer 100 continues to modulate the displacements of Drive motor pumps 80 and 82 to maintain the required speed.

Should a turn be desired, Turn command 202C is issued. In the case of an onboard driver, Turn command 202C is generated by a sensor typically measuring the motion of a steering wheel. In the case of operation from other sources, Turn rate command 202 is configured appropriately. Turn command 202C represents a turn rate of the vehicle. Assume a right turn was required and Speed command 201C required increasing or constant energy, Computer 100 increases the displacement of Left drive motor pump 80 causing it to increase in rotational speed. At the same time it decrease the displacement of Drive motor pump 82 causing it to decrease in rotational speed. Computer 100 uses the rate and magnitude of Turn command 202C as well as the existing vehicle gross weight and center of gravity to develop the magnitude and rate of each of the signals sent to Drive motors 80 and 82 The differential drive wheel rotational speed causes the vehicle to turn, but since the sum of the drive wheel rotational speeds remains constant, the vehicle speed remains unchanged. As Turn command 202C is applied, the vehicle turns in response to the differential rotational drive wheel speeds at a rate following the movement of the steering wheel sensor. As the turn rate of the vehicle resulting from the differential drive wheel rotational speeds changes, the signals emanating from Rate gyro 46 confirm that the turn rate of the vehicle is that of Turn command 202C. If an external perturbation such as a rut in the road causes an uncommanded anomaly in the turn rate, the signal from Rate gyro 62 mitigates the disturbance in the turn rate generated by the perturbation. As the operator increases or decreases the vehicle turn rate command, the displacements of each of the drive motor pumps is modulated to accommodate the command requirements. As the turn rate increases and decreases in response to Turn command 202C the signal from Rate gyro 62 continues to confirm the turn rate. If the existing Speed command 201C required a reduction in speed of the vehicle, Drive motor pumps 80 and 82 would be configured as pumps. In order to accommodate the assumed right turn Computer 100 would decrease the displacement of Left Drive motor pump 80 causing its driving wheel to offer less restraint and increase the displacement of the Right drive wheel motor pump 82 causing its associated driving wheel to provide more restraint, thus causing the vehicle to perform the commanded right turn. If Turn command 202C is to return to zero vehicle turn rate, Computer 100 alters the displacement of Drive motor pumps 80 and 82 to cause them to function at a differential rotational speed that results in zero vehicle turn rate. Maintaining the rotational wheel speeds so that the sum of the wheel speeds remains at Speed command 201C ensures that the vehicle speed is maintained during turning maneuvers.

If an event were to occur that generated an external force on the vehicle such as a side wind gust that causes the vehicle to turn, the action of Rate gyro 62 would return the vehicle to a zero turn condition. Upon the impulse from an external force, the vehicle would initiate a turn. That action would cause an error signal to be generated by Rate Gyro 62. Computer 100 responding to that error signal would modulate the displacement of Left drive motor pump 80 and Right drive motor pump 82 to increase the speed of one drive wheel and decrease the speed of the other drive wheel appropriately until the error signal was cancelled With the removal of that external force the vehicle would again begin to turn. Using the same process, as the vehicle turns, Rate gyro 62 again generates an error signal causing the differential drive wheel rotational speed to return the vehicle to zero turn rate. Thereafter the vehicle would continue with zero turn rate until another perturbation caused the vehicle to depart from the commanded zero turn rate.

If an event such as a blowout or an icy patch of road were to be encountered, the driving force generated by the wheel on the offending side would be reduced. A vehicle turn rate would result. That unwanted turn rate would generate an error signal from Rate Gyro 62. Computer 100 responding to that error signal would increase the speed of the drive wheel in the direction of the turn and decrease the speed of the other drive wheel. If the event caused the drive wheel causing the turn to lose traction, increasing its speed would do little to correct the unwanted turn rate. Reducing the speed of the other drive wheel would accomplish the desired results. The vehicle might even come to a complete stop but the commanded zero turn rate would be satisfied. If Speed command 201C or Brake command 204C were to be issued while the vehicle was moving in reverse the unwanted action would be mitigated with the correct phasing. It is assumed that the operator would respond to the emergency and remove Speed command 201C. All of the automatic events described occur so quickly that corrective operator action is not required thus removing the hazard of spinout accidents.

A turn rate could be commanded that could cause the vehicle to overturn at the existing speed. As the vehicle enters the turn, the roll angle of the vehicle would increase. Up to the time the centrifugal force on the vehicle results in a roll angle of the vehicle that is within the elastic limits of the roll mounts of Control moment gyro 110, the vehicle is free to roll. When the roll angle of the vehicle reaches the roll travel limits established by the roll axis mounts of Control moment gyro 110, the gyro stiffness exerted by Control moment gyro 110 resists the roll motion of the vehicle. At the same time, Computer 100 using data provided by Gyro roll angle sensor 115 applies Pitch gimbal lock 118 to the pitch gimbal of Control moment gyro 110 preventing Control moment gyro 110 from precessing. Thereafter the entire inertial stiffness of Control moment gyro 110 is applied to prevent roll motion of the vehicle. The restraining force resulting from the inertial stiffness of Control moment gyro 110 prevents the vehicle from rolling over. It may skid off the road but it will not roll.

When the vehicle returns to a roll attitude within the limits of the roll mount of Control moment gyro 110, Computer 100 removes Pitch gimbal lock 118 from the pitch gimbal of Control moment gyro 110.

At any time it is desired to maintain a straight-line path either forward or reverse, there is no turn signal generated by the operator. Continuous forces such as those resulting from side wind, road slope, uneven tire wear or others cause the vehicle to depart from the desired straight path. Rate gyro 62 detects any change in the longitudinal axis of the vehicle. Rate gyro 62 sends a signal to Computer 100 representing the unwanted vehicle turn rate. Computer 100 alters the displacement of Left drive motor pump 80 and Right Drive motor pump 82 appropriately to change the differential rotational speed of the driving wheels such that the turn rate of the vehicle as measured by Rate gyro 62 is returned to zero. At zero turn rate the vehicle traverse a straight-line path. Continuing offset signals may be required as an example, due to tire wear of one of the driving wheels or a sustained side wind. In that case, Computer 100 integrates the offset signals and adjusts each wheel speed to continue at the appropriate slightly differential rate. No corrective action is required on the part of the operator.

The vehicle is dynamically suspended being supported by the position of Hydraulic Cylinder 30 suspending the front wheels and rear wheels.

When the vehicle is not in motion, the physical position of the pistons of Hydraulic 30 is determined by the gross weight of the vehicle and the setting of Flow control valves 40 in conjunction with Springs 42. The pressurized out put of each of the Hydraulic cylinders 30 is presented to its associated Flow control valve 40. Computer 100 adjusts the setting of Flow control valve 40 to provide a minimum restriction to flow. Fluid is allowed to flow into Surge tank 88 until the pressure generated by the force on the suspension cylinders reaches equilibrium with the pressure existing in Surge tank 88. With no outside vertical forces being exerted on the vehicle it remains in that static position.

While in motion it is desirable for the vehicle to be operated in a level attitude. Computer 100, using roll and pitch attitudes as identified by Pitch angle sensor 117 and Roll angle sensor 115 calculates the flow rate that is required by Flow control valves 40 associated with each wheel to cause the vehicle to be in a level attitude. At the time the vehicle is static no fluid is processed through Flow control valves 40. Upon moving the vehicle, the vehicle may bounce vertically, may roll from external forces being applied, or the wheels may bounce as each individually hits a bump in the road. Each vertical perturbation resulting in an attitude change of the vehicle generates a signal from Pitch angle sensor 117 and Roll angle sensor 115. Those signals are integrated and applied to the appropriate Flow control valve 40 to cause the required flow to be processed by Flow control valves 40 thus maintaining a level vehicle attitude.

Each Cylinder 30 functions as a bounce generator. As a bump in the road is encountered, or the vehicle rolls within the elastic limits of Control moment gyro 110 the wheel being suspended upon that Cylinder 30 exerts an upward force on the piston of Hydraulic cylinder 30, so that it moves in an upward direction. That action compresses Springs 42 as well as the hydraulic fluid in Hydraulic cylinder 30 being exposed to the wheel bounce. The compressed hydraulic fluid is forced through Outflow check valve 38, through Flow control valve 40 into Surge tank 88. That increment of hydraulic fluid adds an increment of energy to Surge tank 88. For a given perturbation, the amount of the displacement of the piston of the Hydraulic cylinder 30 is controlled by the spring rate of Springs 42 as well as by the existing setting of Flow control valve 40 associated with that Hydraulic cylinder 30.

When the upward motion of the wheel reaches its limit, it commences a downward motion driven by the energy that had been stored in Springs 42 during the upward motion of the piston. As it does, fluid is drawn from storage tank 90 into the Hydraulic cylinder 30 through Inflow Check valve 36. By that described action each wheel functions as a hydraulic pump as the vehicle encounters bumps in the road or rolls from an external force. That function is called the Wheel bounce generator. If a circumstance were to exist in which the entire energy system was a full capacity and additional energy was developed by the Wheel bounce generators, the fluid sent to Surge tank 88 would increase the pressure level in Surge tank 88 to a point that Pressure relief valve 66 would open relieving the excess Surge tank 88 pressure.

If the stored energy in the system has reached its minimum, as determined by the speed of Control moment gyro 110 and the pressure in Surge tank 88, Engine 72 is started. Engine motor pump 74 sends pressurized hydraulic fluid to Surge tank 88. Surge tank 88 continues to fill until it has reached its preset capacity. The spinning wheel of Control moment Gyro 110 functions as a flywheel with the amount of energy stored in the wheel being a function of its size and speed. Energy is added to Control moment gyro 110 by causing its wheel speed to be increased by Gyro motor pump 112 functioning as a motor. When Computer 100 determines that Control moment gyro 110 has reached its nominal wheel speed as measured by Gyro wheel speed sensor 114, Computer 100 configures Gyro motor pump shuttle 136 to configure Gyro motor pump 112 as a pump. The energy storage system is now filled to capacity and Engine 72 is shut off. Until energy is demanded, Control moment gyro 110 continues to spin unimpeded with only the friction developed by its bearings reducing the stored energy. As such it continues to spin indefinitely.

Surge tank 88 is a conventional accumulator with a small amount of stored energy. If the vehicle is at rest and there is no energy drain from accessories, there is no energy dissipation.

Should the operator demand that motion be initiated, energy is dispensed from Surge tank 88 to the required load. If motion of the vehicle was commanded, hydraulic fluid is sent to Drive motor pumps 80 and 82. As motor pumps 80 and 82 move they deplete the stored energy in Surge tank 88, that energy level being measured by Surge tank pressure sensor 89. As the vehicle moves, bumps in the road are encountered which cause the bounce generators to automatically generate replacement energy in Surge tank 88. Braking and decelerations add to the energy storage level in Surge tank 88. While those increments of energy are useful, they are insufficient to maintain continued vehicle motion and further energy is depleted from Surge tank 88. When the energy level in Surge tank 88 reaches a preset lower level, Computer 100 ensures that Gyro motor pump shuttle 136 is configured to cause Gyro motor pump 112 to function as a pump. The displacement of Drive motor pump 112 is modulated by Computer 100 in accordance with the rate of energy being demanded from Surge tank 88. Rotational energy from the wheel of Control moment gyro 110 drives Gyro motor pump 112 to pump fluid into Surge tank 88. When Surge tank 88 reaches its preset upper limit of stored energy, the displacement of Gyro drive motor 112 is reduced to zero and the gyro wheel is again allowed to spin unimpeded.

Constant speed cruise condition of the vehicle uses energy at a reasonably small rate. Acceleration demand more energy. Maximum acceleration demands a large amount of energy but for a short time. Drive motor pump 80 and 82 are sized to be able to provide adequate horsepower to accelerate at the maximum required rate to the maximum desired speed in the desired time. That horsepower and speed requires a large flow of hydraulic fluid but only for a short time. The large flow must be developed from the only sources from which large flows are available; that is Control moment gyro 110, Surge tank 88 and Engine 72. Engine 72 is sized to provide an amount of energy significantly larger than the incremental amount of energy needed for the normal vehicle operating conditions but insufficient to support the flow requirements of a maximum rate acceleration. Thus as the vehicle operates, when it has depleted the total stored energy to a preset level, Engine 72 restores the depleted energy in a relatively short time, then shuts down. The magnitude of the required energy storage is such that as the vehicle continues to operate and traverse over a distance, a preset lower limit of stored energy is reached. A significantly longer time was required while operating on the stored energy than was required by the engine to restore the required stored energy levels. The amount of energy required to provide the maximum vehicle acceleration determines the lower limit of total stored energy. The available stored energy when augmented by the engine must provide sufficient acceleration energy to meet the maximum acceleration requirement. Control moment gyro 110 is never allowed to reach a lower limit such that a combination of its stored energy and that simultaneously provided by Engine 72 is insufficient to meet the maximum acceleration energy requirements.

The control system allows the vehicle to operate with maximum efficiency and safety. Computer 100 is a set of two identical computers. All sensors related to the safety of the control system are triplex. The dual Computers 100 continuously self-test themselves. Both computers continuously perform the required calculations necessary to operate the vehicle. The commands from one of the two computers called the active computer are used to operate the vehicle. The commands developed by the other computer called the hot spare, are identical but are not used until a failure has occurred. If either of the computers detects a failure during its self-test, the vehicle is allowed to operate for a short time while being directed by the spare computer, just long enough to get to safety and then the vehicle operation is terminated. In the processing of the signals generated by the triplex sensors, all three of the signals are processed and compared. If the one of the signals emanating from one of the triplex sensors is different from the other two, the computer that is active determines that a failure has occurred. It generates commands represented by the two identical signals, and allows the vehicle to operate just long enough to get to safety.

Thus it is shown that the objects of the present invention are met. The inefficiencies of complicated gear trains, wasteful friction braking, and idling losses are removed. The enormous engine losses resulting from a huge engine running full time are gone. A small engine running efficiently less that 10% of the time serving a large energy storage system is implemented in its place. Rather than waste the kinetic energy of the vehicle, it is harvested and reused. Even the roughness of the road contributes to energy recovery. The engine may be any engine or motor deriving energy from any available source therefore allowing maximum flexibility and the opportunity to take advantage of increasing fuel-efficient technologies.

The ability to operate the vehicle from on board or remote commands provides the expansion of the usage of surface vehicle into applications not available but highly desirable at this time.

Actions controlled by the computer and the use of gyroscopes would save countless lives by preventing spinout and rollover accidents.

If the vehicle were to be configured as a conventional passenger car, its physical appearance and operator training would remain the same. The difference is in the mechanical systems. It is manufactured using existing components or components from manufacturers of similar parts thus requiring no component research and development. Its ownership costs are minimized since the assemblies are simple to manufacture and have extremely long life cycles. As a vehicle platform it allows for a multitude of cargo uses, extending from various styles of passenger bodies through military and security uses. In the future as public traffic management facilities are developed it is immediately available as the method of transporting passengers under traffic control systems similar to the current aircraft traffic control system.

I claim:

1. A Hydraulically self propelled, gyroscopically stabilized, ground based, wheeled motor vehicle with supporting computer controlled vehicle control system capable of carrying cargo including people comprising:
(a) A mechanical frame upon which is mounted the required computerized electrical, hydraulic, pneumatic, gyroscopic and computer managed functional components, and
(b) A redundant central computer control system capable of processing input and output electrical signals through appropriate electronics to said functional components, and
(c) An energy management program directing the control of a mechanical, hydraulic and pneumatic energy storage acquisition and dispensing system, and
(d) An engine or motor mounted in said mechanical frame capable of driving a hydraulic pump, and
(e) A propulsion, braking, deceleration and steering system utilizing hydraulic motor pumps operating vehicle drive wheels and additional castoring support wheels. and
(f) A suspension system providing computer controlled active vehicle suspension resulting in vehicle dynamic stability and energy recovery.

2. The redundant central computer control system of claim 1 wherein means are provided to control the motions of said vehicle platform in accordance with signals derived from on board sensors, on board programs or from remote signals generated elsewhere.

3. The redundant central computer control system of claim 1 utilized in a ground based wheeled vehicle wherein continuous self monitoring and redundant signals winch are compared for validity are implemented thus providing means to ensure continued undiminished vehicle performance upon the incidence of a component failure.

4. The redundant central computer control system of claim 1 wherein means are implemented to cause said vehicle to operate in accordance with its physical inertial dynamic parameters including its gross weight and center of gravity.

5. An energy management program directing the control of a mechanical, hydraulic and pneumatic energy storage acquisition and dispensing system of claim 1 wherein the mechanical storage is an inertia wheel functioning as an energy wheel and as a gyroscopic whose energy level and inertial stiffness is controlled by the use of a hydraulic motor pump.

6. An energy management program directing the control of a mechanical, hydraulic and pneumatic energy storage acquisition and dispensing system of claim 1 wherein the hydraulic and pneumatic energy storage is a conventional hydraulic pneumatic accumulator.

7. An energy management program of claim 1 directing the control of a mechanical, hydraulic and pneumatic energy storage acquisition and dispensing system wherein the energy acquisition is either from said engine driving said hydraulic pump or from energy derived external to said vehicle that is dispensed by means of hydraulic motor pumps.

8. An energy management program directing the control of a mechanical, hydraulic and pneumatic energy storage acquisition and dispensing system of claim 1 wherein the gyroscopic inertial stiffness of said inertia wheel providing said mechanical energy storage provides means to prevent accidental rollover of said motor vehicle.

9. An engine or motor mounted in said mechanical frame capable of driving a hydraulic pump of claim 1 wherein said engine or motor utilizing energy from any available fuel for which it us designed functions as a prime mover of a hydraulic pump acquiring energy to be added to said vehicle storage system.

10. A propulsion, braking, deceleration, and steering system of claim 1 wherein propulsion is derived from drive wheels of said vehicle being connected to variable displacement hydraulic motor pumps functioning as motors.

11. A propulsion, braking, deceleration and steering system of claim 1 wherin braking and deceleration is derived from variable displacement hydraulic motor pumps functioning as pumps while being connected to the drive wheels of said vehicle.

12. A propulsion, braking, deceleration and steering system of claim 1 wherein emergency braking may be applied by electric brakes to drive wheels and castoring wheels of said vehicle.

13. A propulsion, braking, deceleration and steering system of claim 1 wherin steering is accomplished by the controlled differential rotating speed of the drive wheels of said vehicle.

14. A propulsion braking, deceleration and steering system of claim 1 wherein vehicle steering is stabilized by the use of a rate gyroscope.

15. A suspension system providing computer controlled active vehicle suspension of claim 1 wherein either static or a continuously varying weight of said vehicle is suspended upon hydraulic cylinders and associated springs with resulting deflection being dynamically controlled by said central computer control system.

16. A suspension system providing computer controlled active vehicle suspension of claim 1 wherin the hydraulic cylinders providing support for the vehicle weight also function as hydraulic pumps responding to bumps in the road surface that pump hydraulic fluid that increases the level of energy storage of said energy management system.
